(19) United States
(12) Patent Application Publication
(10) Pub. No.: US 2017/0018788 A1
(43) Pub. Date: Jan. 19, 2017

(54) FUEL SUPPLY UNIT

(71) Applicant: AISAN KOGYO KABUSHIKI KAISHA, Obu-shi (JP)

(72) Inventor: Sadatsugu NAGATA, Aichi-gun (JP)

(73) Assignee: AISAN KOGYO KABUSHIKI KAISHA, Obu-shi (JP)

(21) Appl. No.: 15/201,975

(22) Filed: Jul. 5, 2016

(30) Foreign Application Priority Data
Jul. 17, 2015 (JP) 2015-142535

(51) Int. Cl. H01M 8/04082; H01M 8/2484; H01M 8/04089

(52) U.S. Cl. CPC H01M 8/04201; H01M 8/04089; H01M 8/2484

(57) ABSTRACT

Each injector is placed and held between an inflow block and an outflow block. An inlet pipe of each injector is connected with an inlet hole of the inflow block via a sealing member, and an outlet pipe of each injector is connected with an outlet hole of the outflow block via a sealing member. An inflow pipe to introduce fuel gas is connected with an inflow port of the inflow block via a sealing member, and an outflow pipe to allow the fuel gas to flow out is connected with an outflow port of the outflow block via a sealing member. The inflow block has inner peripheral surfaces defining the inflow port and the inlet hole and each being formed as a smooth sealing surface finished by one of pressurizing and pressing, the corresponding sealing member being held in contact with a part of the inner peripheral surface.

### CROSS-REFERENCE TO RELATED APPLICATIONS

This application is based upon and claims the benefit of priority from the prior Japanese Patent Application No. 2015-142535, filed Jul. 17, 2015, the entire contents of which are incorporated herein by reference.

### BACKGROUND OF THE INVENTION

Field of the Invention

The present invention relates to a fuel supply unit used for regulating a flow rate and pressure of fuel gas that will be supplied from a fuel container to a supply destination.

Related Art

Heretofore, a gas supply device in a fuel cell system described in Japan Patent Application Publication No. 2012-156033 (JP-A-2012-156033) has been known as one example of a fuel supply unit. The fuel cell system includes a fuel cell to generate electricity by an electrochemical reaction of hydrogen gas and air, a hydrogen tank in which the hydrogen gas is stored, and a hydrogen supply passage to supply the hydrogen gas in the hydrogen tank to the fuel cell. The hydrogen supply passage is provided with a gas supply device to regulate a flow rate and pressure of the hydrogen gas which will be supplied to the fuel cell. The gas supply device includes a plurality of injectors, a fuel gas supply manifold, and an end plate. The injectors are arranged in parallel and held between the fuel gas supply manifold and the end plate. The manifold placed on an inlet side of the injectors includes a gas supply passage to supply the fuel gas to each injector and a plurality of inlet holes each of which is connected with an inlet pipe of each injector. The end plate placed on an exit side of the injectors includes a gas supply passage to take in the fuel gas injected through the injectors and a plurality of outlet holes each of which is connected with an outlet pipe of each injector. Each inlet hole is press-fitted and connected with the corresponding inlet pipe via a sealing member. Each outlet hole is press-fitted and connected with the corresponding outlet pipe via a sealing member. The end plate and the manifold are conceivably made of metal.

### SUMMARY OF INVENTION

### Problems to be Solved by the Invention

In the gas supply device described in JP-A-2012-156033, the manifold is conceivably formed by a method such as casting and die casting. When forming a manifold by casting or die casting, there is a possibility of generating cavities inside a formed product due to intrusion of air. As shown in a sectional view of FIG. 9, the cavities are generated in portions including a vicinity of an inner peripheral surface of a block 91 of the manifold defining an inlet hole 92. To improve a sealing surface roughness of the inlet hole 92, a cutting process has been adopted for processing the inner peripheral surface. This cutting process may however lead to exposure of cavities 93 on a surface as shown in FIG. 10 (exposed cavities are each assigned with a reference sign “93a” in the drawing). The thus exposed cavities 93 remain as recesses on the surface when the inlet pipe of the injector is press-fitted in the inlet hole 92 via a sealing member, failing to assure a sealing performance and leading to a possibility of leakage of the fuel gas. While a surface roughness of the block formed by die casting is represented as “Ra is 3.2 to 6.3” and the surface roughness of the block formed by casting is represented as “Ra is 13 or more,” the surface roughness of the block formed by cutting is represented as “Ra is 0.1 or more,” which is worse than the above forming methods of casting and die casting. FIG. 9 is a schematic enlarged sectional view showing a part of the inlet hole 92 and the cavities 93. FIG. 10 is a schematic enlarged sectional view showing the inner peripheral surface of the inlet hole 92 which has been formed by the cutting process.

The present invention has been made in view of the above circumstance and has a purpose of providing a fuel supply unit including an inflow passage to introduce fuel gas and enabling to improve a sealing performance of a sealing member to seal a sealing surface of the inflow block formed by casting or die casting against the fuel gas.

### Means of Solving the Problems

To achieve the above purpose, one aspect of the present invention provides a fuel supply unit comprising: an inflow block formed by one of casting and die casting and having an inflow passage configured to introduce fuel gas; an outflow block formed by one of casting and die casting and having an outflow passage configured to allow the fuel gas to flow out; and at least one injector configured to regulate a flow rate and pressure of the fuel gas, wherein the injector includes an inlet pipe configured to introduce the fuel gas and an outlet pipe configured to inject the fuel gas, the injector is placed and held between the inflow block and the outflow block, the inflow block includes an inflow port configured to introduce the fuel gas into the inflow passage and an inlet hole connected with the inlet pipe of the injector and communicated with the inflow passage, the outflow block includes an outflow port configured to allow the fuel gas to flow out of the outflow passage and an outlet hole connected with the outlet pipe of the injector and communicated with the outflow passage, the inlet pipe of the injector is connected with the inlet hole of the inflow block via a sealing member and the outlet pipe of the injector is connected with the outlet hole of the outflow block via a sealing member, an inflow pipe configured to introduce the fuel gas is connected with the inflow port of the inflow block via a sealing member and the outflow pipe configured to allow the fuel gas to flow out is connected with the outflow port of the outflow block via a sealing member, the fuel gas supply unit is configured such that the fuel gas introduced in the inflow passage is injected to the outflow passage through the injector to decompress the fuel gas, and the inflow block has inner peripheral surfaces defining the inflow port and the inlet hole and each being formed as a smooth sealing surface finished by one of pressurizing and pressing, the corresponding sealing member being held in contact with a part of the inner peripheral surface. Another aspect of the invention provides a method of manufacturing a fuel supply unit, the fuel supply unit comprising: an inflow block formed by one of casting and die casting and having an inflow passage configured to introduce fuel gas; an outflow block formed by one of casting and die casting and having an outflow passage configured to allow the fuel gas to flow out; and at least one injector configured to regulate a flow rate and pressure of the fuel gas, wherein the injector includes an inlet pipe configured to introduce the fuel gas and an outlet pipe configured to inject the fuel gas, the injector is placed and held between the inflow block and the outflow block, the inflow block includes an inflow port configured to introduce the fuel gas into the inflow passage and an inlet hole connected with the inlet pipe of the injector and communicated with the inflow passage, the outflow block includes an outflow port configured to allow the fuel gas to flow out through the outflow passage and an outlet hole connected with the outlet pipe of the injector and communicated with the outflow passage, the inlet pipe of the injector is connected with the inlet hole of the inflow block via a sealing member and the outlet pipe of the injector is connected with the outlet hole of the outflow block via a sealing member, an inflow pipe configured to introduce the fuel gas is connected with the inflow port of the inflow block via a sealing member and an outflow pipe configured to allow the fuel gas to flow out is connected with the outflow port of the outflow block via a sealing member, the fuel supply unit is configured such that the fuel gas introduced into the inflow passage is injected through the injector to decompress the fuel gas, and the inflow block has inner peripheral surfaces defining the inflow port and the inlet hole and each being formed as a smooth sealing surface finished by one of pressurizing and pressing, the sealing member being held in contact with a part of the inner peripheral surface.

### Effects of the Invention

According to the present invention, an inflow block formed by casting or die casting can achieve the improved sealing performance of sealing members on sealing surfaces to seal an inflow port connected with an inflow pipe configured to introduce fuel gas and an inlet hole connected with an inlet pipe of an injector against fuel gas.

### BRIEF DESCRIPTION OF THE DRAWINGS

FIG. 1 is a sectional view of a hydrogen supply unit in a first embodiment;

FIG. 2 is a sectional view of an inflow block in the first embodiment;

FIG. 3 is a sectional view of an outflow block in the first embodiment;

FIG. 4 is an enlarged sectional view showing a part of an inflow port of the inflow block in the first embodiment;

FIG. 5 is a schematic view showing a method of roller burnishing in the first embodiment;

FIG. 6 is a schematic view showing a method of shot peening in a second embodiment;

FIG. 7 is a sectional view of a hydrogen supply unit in a third embodiment;

FIG. 8 is a sectional view of a hydrogen supply unit in a fourth embodiment;

FIG. 9 is a schematic enlarged sectional view showing a part of an inlet hole and cavities in a related art; and

FIG. 10 is a schematic enlarged sectional view showing a part of an inner peripheral surface of the inlet hole which has been processed by cutting in the related art.

### DESCRIPTION OF EMBODIMENTS

<First Embodiment>

A detailed description of a first embodiment embodying a fuel supply unit embodied in a hydrogen supply unit used for a fuel cell is now given referring to the accompanying drawings.

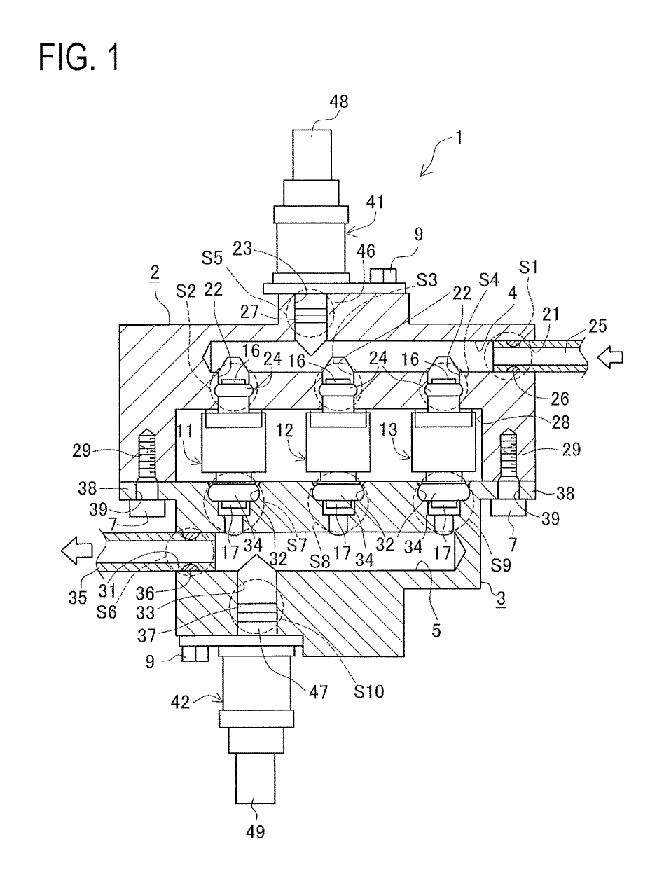

FIG. 1 is a sectional view of a hydrogen supply unit 1. The hydrogen supply unit 1 corresponding to one example of a fuel supply unit is provided in a hydrogen supply passage to supply hydrogen to a fuel cell and regulate a flow rate and pressure of hydrogen gas which will be supplied to the fuel cell as fuel gas. The hydrogen supply unit 1 includes: an inflow block 2 having an inflow passage 4 to which the hydrogen gas is introduced; an outflow block 3 having an outflow passage 5 thorough which the hydrogen gas is allowed to flow out; a first injector 11, a second injector 12, and a third injector 13 to regulate a flow rate and pressure of the hydrogen gas; an inflow pressure sensor 41 to detect the pressure of the hydrogen gas in the inflow passage 4 as inflow pressure; and an outflow pressure sensor 42 to detect the pressure of the hydrogen gas in the outflow passage 5 as outflow pressure. The inflow block 2 and the outflow block 3 are both formed by casting or die casting. Such forming process of casting or die casting may generate minute cavities inside each of the blocks 2 and 3 due to intrusion of air during the process. The hydrogen supply unit 1 is integrally configured such that the injectors 11 to 13 are placed to be held between the inflow block 2 and the outflow block 3.

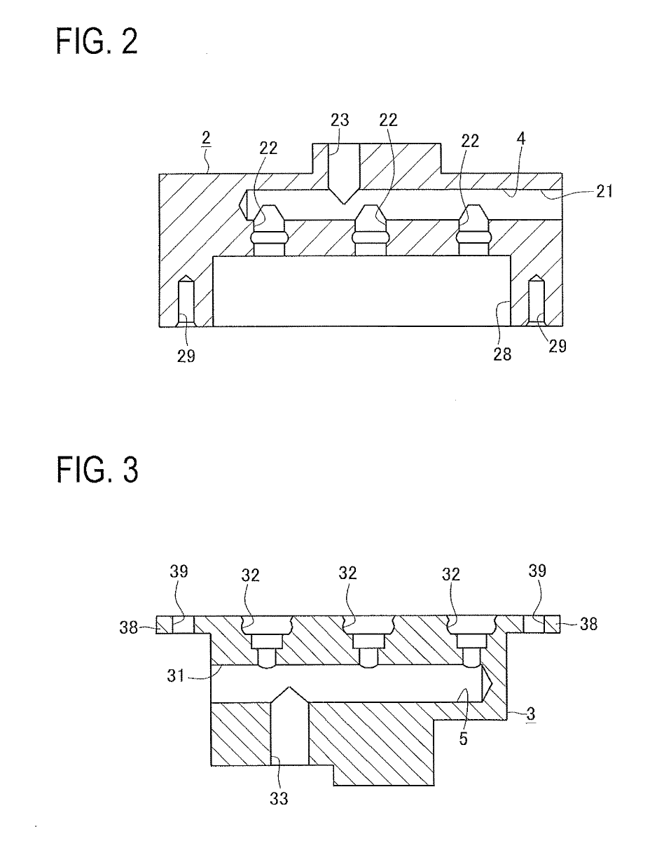

FIG. 2 is a sectional view of the inflow block 2. FIG. 3 is a sectional view of the outflow block 3. As shown in FIGS. 1 and 2, the inflow block 2 includes: an inflow port 21 to introduce the hydrogen gas; a plurality of inlet holes 22, each of which is connected with an inlet pipe 16 of each of the injectors 11 to 13; and an input hole 23 connected with an input pipe 46 of the inflow pressure sensor 41. The inflow port 21, the inlet holes 22, and the input hole 23 are each communicated with the inflow passage 4. The inlet holes 22 are each connected with the inlet pipe 16 of each of the injectors 11 to 13 via a sealing member 24. The inflow port 21 is connected with an inflow pipe 25 via a sealing member 26 to introduce the hydrogen gas. The input hole 23 is connected with the input pipe 46 of the inflow pressure sensor 41 via a sealing member 27.

As shown in FIGS. 1 and 3, the outflow block 3 includes: an outflow port 31 to allow the hydrogen gas to flow out; a plurality of outlet holes 32, each of which is connected with an outlet pipe 17 of the injectors 11 to 13; and an input hole 33 connected with the input pipe 47 of the outflow pressure sensor 42. The outflow port 31, the outlet holes 32, and the input hole 33 are each communicated with the outflow passage 5. The outlet holes 32 are each connected with the outlet pipe 17 of each of the injectors 11 to 13 via a sealing member 34. The outflow port 31 is connected with the outflow pipe 35 via a sealing member 36 to allow the hydrogen gas to flow out. The input hole 33 is connected with the input pipe 47 of the outflow pressure sensor 42 via a sealing member 37.

The inflow block 2 constitutes a delivery pipe to deliver the hydrogen gas to each of the injectors 11 to 13, and the outflow block 3 constitutes a merging pipe to merge the hydrogen gas injected through each of the injectors 11 to 13. Accordingly, the hydrogen supply unit 1 is configured to introduce the hydrogen gas into the inflow passage 4 and inject the thus introduced gas to the outflow passage 5 through the injectors 11 to 13 so that the hydrogen gas is decompressed. The hydrogen gas is thus decompressed in the outflow passage 5, and therefore pressure of the hydrogen gas in the outflow passage 5 is lower than that in the inflow passage 4.

As shown in FIG. 1, the injectors 11 to 13 are each formed in an almost cylindrical shape and each provided with the inlet pipe 16 on one end and the outlet pipe 17 on the other end in a protruding manner. The pressure sensors 41 and 42 formed in an almost cylindrical shape are respectively provided with the input pipes 46 and 47 on one end and connectors 48 and 49 connected to external wirings on the other end in a protruding manner. The sealing members 24, 26, 27, 34, 36, and 37 may be formed by rubber-made O rings or the like.

As shown in FIGS. 1 and 2, the inflow block 2 further includes a housing recess 28 to house main bodies of the injectors 11 to 13 as well as housing the inflow passage 4, the inflow port 21, the inlet holes 22, and the input hole 23. The inflow block 2 is further provided with female thread holes 29 adjacent to both longitudinal ends of the housing recess 28. Further, as shown in FIGS. 1 and 3, the outflow block 3 is provided with flanges 38 and bolt holes 39 formed on both longitudinal ends of the block 3. The inflow block 2 and the outflow block 3 are fastened by two bolts 7 at the flanges 38 on both ends of the outflow block 3. Each bolt 7 is inserted in each bolt hole 39 of the flange 38 and fastened to the female thread hole 29 of the inflow block 2. Thus, the inflow block 2 and the outflow block 3 are coupled.

While the injectors 11 to 13 are placed to be held between the inflow block 2 and the outflow block 3 in the hydrogen supply unit 1, the inflow pressure sensor 41 is placed outside the inflow block 2 (on an upper side in FIG. 1) and the outflow pressure sensor 42 is placed outside the outflow block 3 (on a lower side in FIG. 1). The pressure sensors 41 and 42 are each fixed with a bolt 9. The blocks 2 and 3 are partly formed thick to hold those pressure sensors 41 and 42.

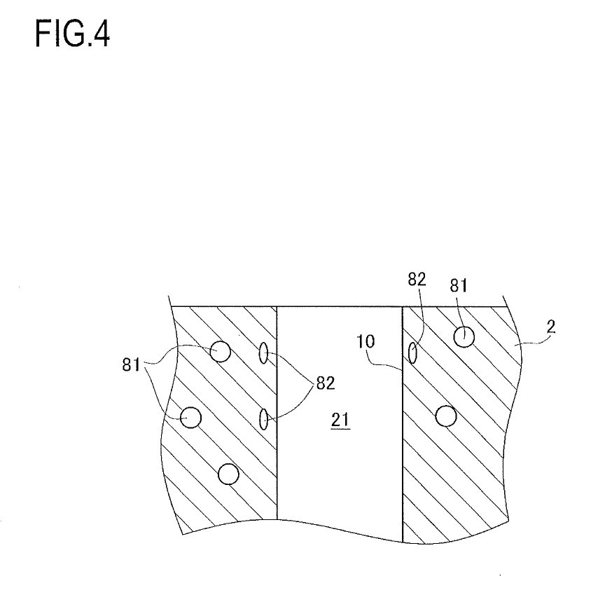

In portions surrounded by dashed circles S1, S2, S3, S4, and S5 in FIG. 1 of the present embodiment, inner peripheral surfaces of the inflow block 2, which are contacted with the sealing members 24, 26, and 27 to connect the inflow port 21, the inlet holes 22, and the input hole 23, are radially expanded by pressurizing or pressing to form smooth sealing surfaces with no exposure of cavities. Further, in portions surrounded by dashed circles S6, S7, S8, S9, and S10 in FIG. 1, inner peripheral surfaces of the outflow block 3, which are contacted with the sealing members 34, 36, and 37 to connect the outflow port 31, the outlet holes 32, and the inlet hole 33, are radially expanded by pressurizing or pressing to form smooth sealing surfaces with no exposure of the cavities. FIG. 4 is an enlarged sectional view of a part of the inflow port 21 of the inflow block 2. The inner peripheral surface in the inflow port 21 is radially expanded by pressurizing or pressing to be finished as a smooth sealing surface with no exposure of the cavities. Herein, as shown in FIG. 4, the inflow block 2 has cavities 81 in its inside, and the cavities 82 are also generated in a vicinity of a sealing surface (surface) 10. However, the cavities 82 close to the surface are flattened inside the block 2 and thus not exposed on the surface. In this manner, the sealing surface 10 is formed as a smooth surface with less unevenness.

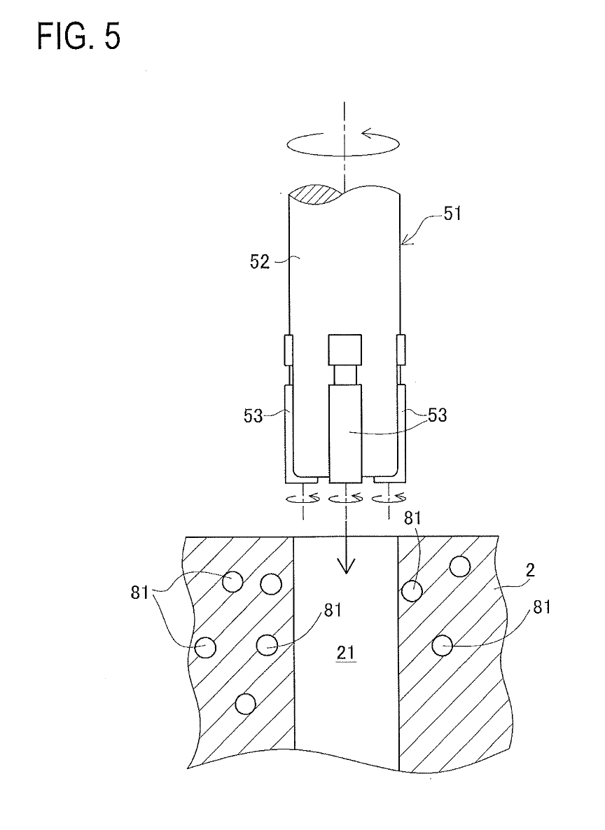

In the present embodiment, a roller burnishing method is adopted as a method of processing the inflow port 21 of the inflow block 2. FIG. 5 is a schematic view of the roller burnishing method. As one example, a roller burnishing tool made by Sugino Machine Limited is utilized in this embodiment. As shown in FIG. 5, a roller burnishing tool 51 is provided on its leading end with a rotatable cylindrical frame 52 and a plurality of rod-like rollers 53 which are rotatably supported by the frame 52. A leading end portion of the tool 51 is firstly press-fitted in the inflow port 21 of the inflow block 2 which has been formed by casting or die casting, and the frame 52 is rotated to pressurize or press the inner peripheral surface in the inflow port 21 with the rollers 53. The roller burnishing tool 51 is one type of mirror finishing tools to flatten a metal surface to be smoothened by the rollers 53. A burnishing process (plastic deformation process) with the rollers 53 plastically deforms only a metal surface, and thus can realize high productivity, fine finishing, and surface improvement (such as improvement in abrasion-resistance and improvement in fatigue strength) at the same time. The roller burnishing method is one method of plastic processing methods of rotating the hard and smooth rollers 53 to be in contact with and compress a metal surface so that a surface layer is locally applied with minute plastic deformation. This method enables to improve surface roughness in short time and simultaneously, the surface gets hardened to generate compressive residual stress, finishing the fine surface with high durability.

FIGS. 4 and 5 illustrate a portion of the inflow port 21 of the inflow block 2, but each portion of the inlet holes 22 and the input hole 23 of the inflow block 2 and each portion of the outflow port 31, the outlet holes 32, and the input hole 33 of the outflow block 3 are also processed as similar to the inflow port 21, and illustration and explanation of those portions are therefore omitted.

According to the above explained hydrogen supply unit 1 of the present embodiment, the inflow block 2 formed by casting or die casting is provided with the inflow port 21 connected with the inflow pipe 25 to introduce the hydrogen gas and the inlet holes 22 connected with the inlet pipes 16 of the injectors 11 to 13, and each inner peripheral surface of the block 2 defining the inflow port 21 and the inlet holes 22 is finished by pressurizing or pressing to form the smooth sealing surface 10 with no exposure of the cavities 81 and 82. This scaling surface 10 has less unevenness and its surface roughness is improved, thereby achieving improvement in hermetical sealing performance of the sealing members 24 and 26 with the sealing surfaces 10. Therefore, in the inflow block 2 formed by casting or die casting, the inflow port 21 connected with the inflow pipe 25 to introduce the hydrogen gas and the inlet holes 22 connected with the inlet pipes 16 of the injectors 11 to 13 can improve the sealing performance of the sealing members 26 and 24 to seal the sealing surfaces 10 against the hydrogen gas.

In the present embodiment, the inflow block 2 includes the input hole 23 connected with the input pipe 46 of the inflow pressure sensor 41, and the inner peripheral surface defining the input hole 23 is finished with pressurizing or pressing to form the smooth sealing surface 10 with no exposure of the cavities 81 and 82. This sealing surface 10 with less unevenness has the improved surface roughness and can achieve improvement in hermetical sealing performance of the sealing member 27 with the sealing surface 10. Accordingly, in the inflow block 2, the input hole 23 connected with the input pipe 46 of the inflow pressure sensor 41 is enabled to improve the sealing performance of the sealing member 27 to seal the sealing surface 10 against the hydrogen gas.

In the present embodiment, the outflow block 3 includes the outflow port 31 connected with the outflow pipe 35 to allow the hydrogen gas to flow out and the outlet holes 32 connected with the outlet pipes 17 of the injectors 11 to 13, and each inner peripheral surface of the outflow block 3 defining the outflow port 31 and the outlet holes 32 is finished with pressurizing or pressing to form the smooth sealing surface 10 with no exposure of the cavities 81 and 82. This sealing surface 10 with less unevenness has the improved surface roughness and can achieve improvement in hermetical sealing performance of the sealing members 36 and 34 with the sealing surfaces 10. Accordingly, in the outflow block 3, the outflow port 31 connected with the outflow pipe 35 to allow the hydrogen gas to flow out and the outlet holes 32 connected with the outlet pipes 17 of the injectors 11 to 13 are enabled to improve sealing performance of the sealing members 36 and 34 to seal the sealing surfaces 10 against the hydrogen gas.

In the present embodiment, the outflow block 3 includes the input hole 33 connected with the input pipe 47 of the outflow pressure sensor 42, and the inner peripheral surface of the outflow block 3 defining the input hole 33 is finished with pressurizing or pressing to form the smooth sealing surface 10 with no exposure of the cavities 81 and 82. This sealing surface 10 with less unevenness has the improved surface roughness and can achieve improvement in hermetical sealing of the sealing member 37 to seal the sealing surface 10. Accordingly, in the outflow block 3 formed by casting or die casting, the input hole 33 connected with the input pipe 47 of the outflow pressure sensor 42 is enabled to improve the sealing performance of the sealing member 37 to seal the sealing surface 10 against the hydrogen gas.

In the present embodiment, the inner peripheral surfaces of the inflow block 2 defining the inflow port 21, the inlet holes 22, and the input hole 23 are processed by roller burnishing as mentioned above, and therefore, hardness of those sealing surfaces 10 is increased. As a result, the sealing surfaces 10 in the inflow port 21, the inlet holes 22, and the input hole 23 can achieve improvement in their durability. Similarly, the inner peripheral surfaces of the outflow block 3 defining the outflow port 31, the outlet holes 32, and the input hole 33 are processed by roller burnishing, increasing the hardness of those sealing surfaces 10. As a result, the sealing surfaces 10 in the outflow port 31, the outlet holes 32, and the input hole 33 can achieve improvement in their durability.

<Second Embodiment>

A detailed description of a second embodiment embodying a fuel supply unit embodied in a hydrogen supply unit used for a fuel cell is now given referring to the accompanying drawings.

Similar components are indicated with the same reference signs with the first embodiment, and explanation thereof is omitted in the following explanation. Accordingly, the explanation is made with a focus on differences from the first embodiment.

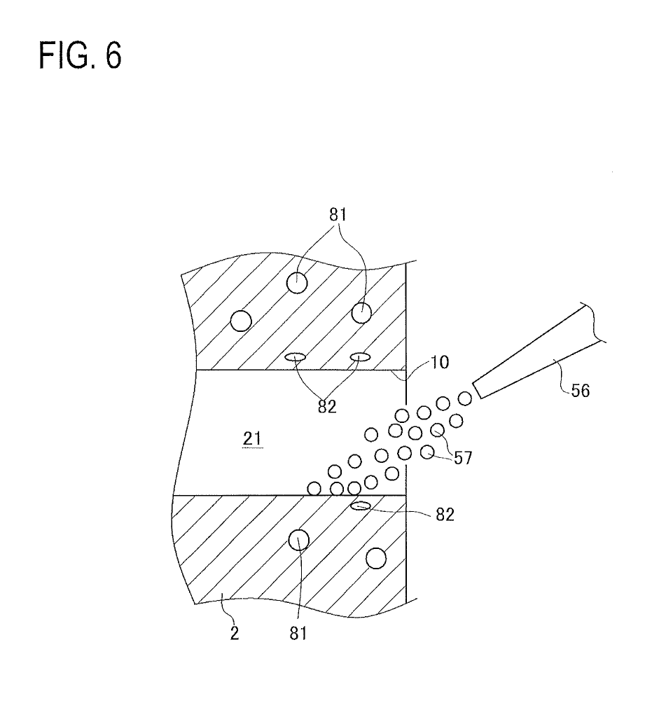

The present embodiment is different from the first embodiment in a method of processing the inflow port 21, the inlet holes 22, and the input hole 23 of the inflow block 2 and the outflow port 31, the outlet holes 32, and the input hole 33 of the outflow block 3. Specifically, the present embodiment adopts a processing method of shot peening instead of roller burnishing. The following explanation is made with the inflow port 21 of the inflow block 2 as a representative example. FIG. 6 is a schematic view of the shot peening process. As shown in FIG. 6, a nozzle 56 is obliquely placed to be directed to the inner peripheral surface of the inflow block 2 defining the inflow port 21, and numerous shots 57 are injected at high speed to collide against the inner peripheral surface. The inflow block 2 or the nozzle 56 may be rotated so that the shots 57 equally abut over the inner peripheral surface in the inflow port 21. Thus, the inner peripheral surface in the inflow port 21 is radially expanded by pressurizing or pressing to form the smooth sealing surface 10 with no exposure of the cavities 81 and 82. Further, the sealing surface 10 processed with shot peening can achieve increase in hardness of the surface, and the compressive residual stress applied on the surface layer offsets with the repetitive load to increase the fatigue strength. Furthermore, the present embodiment can achieve improvement in abrasion resistance, improvement in stress corrosion cracking resistance, improvement in heat radiation, decrease in fluid resistance, and others.

The above mentioned hydrogen supply unit 1 of the present embodiment has the different processing method from the first embodiment, but has the similar operations and effects to the first embodiment.

<Third Embodiment>

A detailed description of a third embodiment embodying the fuel cell unit embodied in a hydrogen supply unit used for a fuel cell is now given referring to the accompanying drawings.

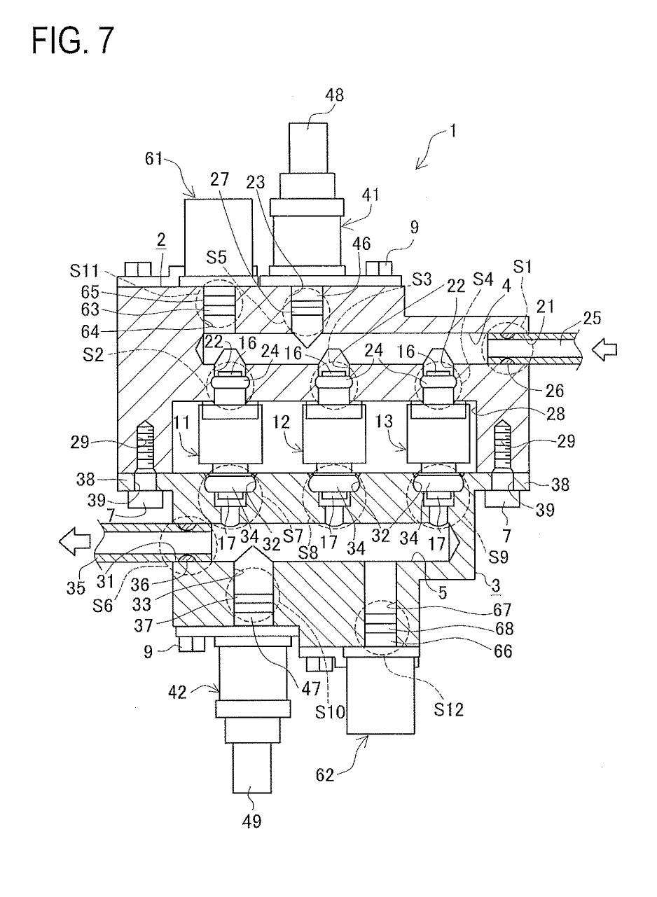

FIG. 7 is a sectional view of the hydrogen supply unit 1 of the present embodiment. The present embodiment is different from the above embodiments in its configuration that the hydrogen supply unit 1 is further provided with an inflow pressure relief valve 61 and an outflow pressure relief valve 62. To be specific, the inflow block 2 is provided with the inflow pressure relief valve 61 to release the pressure of the hydrogen gas in the inflow passage 4 to outside. The inflow block 2 is further provided with an inlet hole 64 connected with an input pipe 63 of the inflow pressure relief valve 61, and this inlet hole 64 is communicated with the inflow passage 4. To this inlet hole 64, the input pipe 63 of the inflow pressure relief valve 61 is connected via a sealing member 65. Similarly, the outflow block 3 is provided with the outflow pressure relief valve 62 to release the pressure of the hydrogen gas in the outflow passage 5 to outside. The outflow block 3 is further provided with an inlet hole 67 connected with an input pipe 66 of the outflow pressure relief valve 62, and this inlet hole 67 is communicated with the outflow passage 5. To this inlet hole 67, the input pipe 66 of the outflow pressure relief valve 62 is connected via a sealing member 68.

In portions surrounded by dashed circles S11 and S12 in FIG. 7 of the present embodiment, an inner peripheral surface of the inflow block 2 defining the inlet hole 64 and an inner peripheral surface of the outflow block 3 defining the inlet hole 67, which are respectively contacted with the sealing members 65 and 68, are radially expanded by pressurizing or pressing to form the smooth surfaces 10 with no exposure of the cavities 81 and 82. As a processing method for the sealing surfaces of the inlet holes 64 and 67, the roller burnishing method or the shot peening method may be adopted as similar to the above embodiments.

Accordingly, the hydrogen supply unit 1 of the present embodiment can achieve the similar operations and effects to the first embodiment. Further, the hydrogen supply unit 1 of the present embodiment can improve the sealing performance to seal the sealing portion between the input pipe 63 of the inflow pressure relief valve 61 and the inlet hole 64 of the inflow block 2, and also improve the sealing performance to seal the sealing portion between the input pipe 66 of the outflow pressure relief valve 62 and the inlet hole 67 of the outflow valve 3.

The inflow block 2 includes the inlet hole 64 connected with the input pipe 63 of the inflow pressure relief valve 61, and the inner peripheral surface defining the inlet hole 64 is finished with pressurizing or pressing to form the smooth sealing surface 10 with no exposure of the cavities 81 and 82. This sealing surface 10 with less unevenness enables to improve its surface roughness and improve hermetical sealing of the sealing member 65 with the sealing surface 10. As a result, the inflow block 2 can improve the sealing performance of the sealing member 65 to seal the sealing surface 10 of the inlet hole 64 connected with the input pipe 63 of the inflow pressure relief valve 61 against the hydrogen gas. Further, the outflow block 3 includes the inlet hole 67 connected with the input pipe 66 of the outflow pressure relief valve 62, and the inner peripheral surface defining the inlet hole 67 is finished with pressurizing or pressing to form the smooth sealing surface 10 with no exposure of the cavities 81 and 82. This sealing surface 10 with less unevenness can improve its surface roughness and improve hermetical sealing of the sealing member 68 to seal the sealing surface 10. As a result, in the outflow block 3, the inlet hole 67 connected with the input pipe 66 of the outflow pressure relief valve 62 can have the improved sealing performance of the sealing member 68 to seal the sealing surface 10 against the hydrogen gas.

<Fourth Embodiment>

A detailed explanation of a fourth embodiment embodying the fuel supply unit embodied in a hydrogen supply unit used for a fuel cell is now given referring to the accompanying drawings.

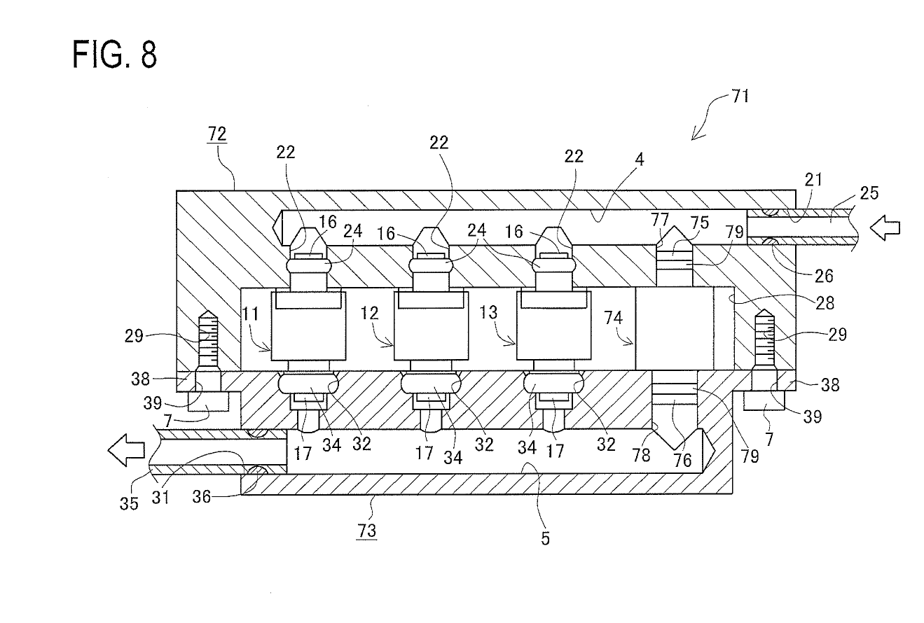

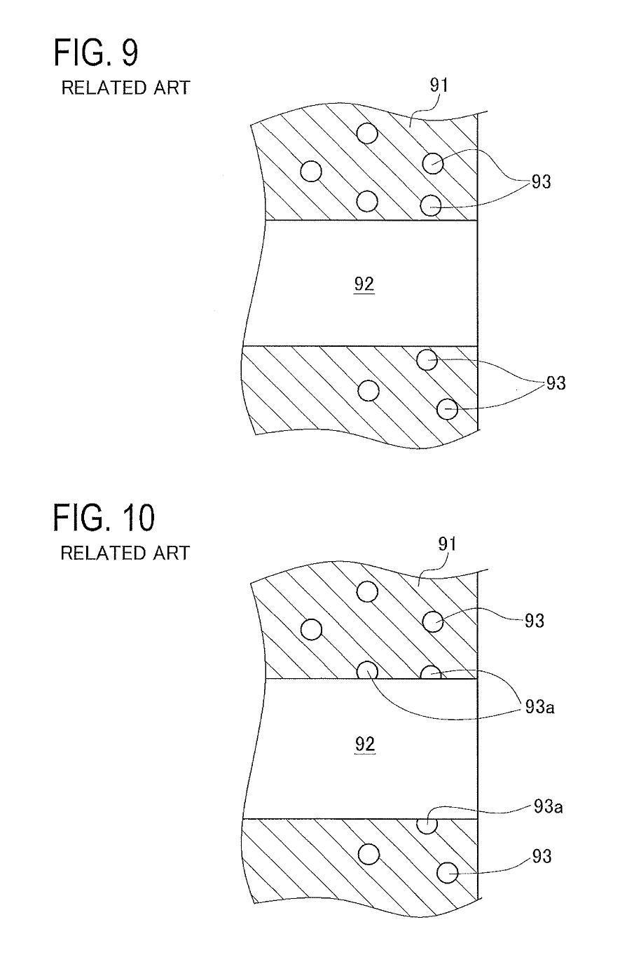

The present embodiment is different from the above mentioned embodiments in a part of configuration of the hydrogen supply unit. FIG. 8 is a sectional view of a hydrogen supply unit 71 of the present embodiment. Each configuration of an inflow block 72 and an outflow block 73 of the present embodiment is different from each of the inflow block 2 and the outflow block 3 of the above embodiments. Further, the present embodiment is different from the above embodiments in a configuration that a single pressure sensor 74 configured to detect both the inflow pressure and the outflow pressure is provided instead of the inflow pressure sensor 41 and the outflow pressure sensor 43, and the pressure sensor 74 is placed in parallel with the injectors 11 to 13 to be held between the inflow block 72 and the outflow block 73. Other configurations are similar to those in the above embodiments.

As shown in FIG. 8, the pressure sensor 74 includes a first input pipe 75 to input the inflow pressure and a second input pipe 76 to input the outflow pressure. Further, the inflow block 72 is provided with an input hole 77 to input the inflow pressure in the inflow passage 4, and the outflow block 73 is provided with an input hole 78 to input the outflow pressure in the outflow passage 5. To the input hole 77 of the inflow block 72, the first input pipe 75 to introduce the inflow pressure is connected via a sealing member 79, and to the input hole 78 of the outflow block 73, the second input pipe 76 to introduce the outflow pressure is connected via the sealing member 79. In those input holes 77 and 78, the inner peripheral surfaces contacted with the sealing member 79 are applied with the method of roller burnishing or shot peening to radially expand the inner peripheral surface by pressurizing or pressing so that the smooth sealing surfaces 10 with no exposure of the cavities 81 and 82 are formed.

The above explained hydrogen supply unit 71 can achieve the similar operations and effects to the above mentioned embodiments.

The present invention is not limited to the above mentioned embodiments and may be changed or modified as appropriate without departing from the essential characteristics thereof.

In the above embodiments, the hydrogen supply units 1 and 71 are each provided with the three injectors 11 to 13, but the number of injectors is not limited to three, and may be one or any other plural numbers other than three.

The fuel supply unit is embodied in the hydrogen supply units 1 and 71 in the above embodiments, but the unit may be any one to supply the fuel gas other than the hydrogen gas such as an LNG supply unit to supply liquefied natural gas (LNG).

### INDUSTRIAL APPLICABILITY

The present invention may be utilized for a fuel supply apparatus to supply fuel gas from a fuel container to a supply destination.

### REFERENCE SIGNS LIST

1 Hydrogen supply unit (fuel supply unit)

2 Inflow block

3 Outflow block

4 Inflow passage

5 Outflow passage

10 Sealing surface

11 First injector

12 Second injector

13 Third injector

16 Inlet pipe

17 Outlet pipe

21 Inflow port

22 Inlet hole

23 Input hole

24 Sealing member

25 Inflow pipe

26 Sealing member

27 Sealing member

31 Outflow port

32 Outlet hole

33 Input hole

34 Sealing member

35 Outflow pipe

36 Sealing member

37 Sealing member

41 Inflow pressure sensor

42 Outflow pressure sensor

46 Input pipe

47 Input pipe

61 Inflow pressure relief valve

62 Outflow pressure relief valve

63 Input pipe

64 Inlet hole

65 Sealing member

66 Input pipe

67 Inlet hole

68 Sealing member

71 Hydrogen supply unit

72 Inflow block

73 Outflow block

74 Pressure sensor (inflow pressure sensor, outflow pressure sensor)

75 First input pipe

76 Second input pipe

77 Input hole

78 Input hole

79 Sealing member

81 Cavity

82 Cavity (in a vicinity of a sealing surface)

What is claimed is:

1. A fuel supply unit comprising: an inflow block formed by one of casting and die casting and having an inflow passage configured to introduce fuel gas; an outflow block formed by one of casting and die casting and having an outflow passage configured to allow the fuel gas to flow out; and at least one injector configured to regulate a flow rate and pressure of the fuel gas,
wherein the injector includes an inlet pipe configured to introduce the fuel gas and an outlet pipe configured to inject the fuel gas,
the injector is placed and held between the inflow block and the outflow block,
the inflow block includes an inflow port configured to introduce the fuel gas into the inflow passage and an inlet hole connected with the inlet pipe of the injector and communicated with the inflow passage,
the outflow block includes an outflow port configured to allow the fuel gas to flow out of the outflow passage and an outlet hole connected with the outlet pipe of the injector and communicated with the outflow passage,
the inlet pipe of the injector is connected with the inlet hole of the inflow block via a sealing member and the outlet pipe of the injector is connected with the outlet hole of the outflow block via a sealing member,
an inflow pipe configured to introduce the fuel gas is connected with the inflow port of the inflow block via a sealing member and the outflow pipe configured to allow the fuel gas to flow out is connected with the outflow port of the outflow block via a sealing member,
the fuel gas supply unit is configured such that the fuel gas introduced in the inflow passage is injected to the outflow passage through the injector to decompress the fuel gas, and
the inflow block has inner peripheral surfaces defining the inflow port and the inlet hole and each being formed as a smooth sealing surface finished by one of pressurizing and pressing, the corresponding sealing member being held in contact with a part of the inner peripheral surface.

2. The fuel supply unit according to claim 1, wherein the outflow block has inner peripheral surfaces defining the outflow port and the outlet hole and each being formed as the smooth sealing surface finished by one of pressurizing and pressing, the corresponding sealing member being held in contact with a part of the inner peripheral surface.

3. The fuel supply unit according to claim 1, wherein
the fuel supply unit further includes an inflow pressure sensor configured to detect pressure of the fuel gas in the inflow passage as inflow pressure,
the inflow pressure sensor includes an input pipe configured to input the inflow pressure,
the inflow block includes an input hole connected with the input pipe of the inflow pressure sensor and communicated with the inflow passage,
the input pipe of the inflow pressure sensor is connected with the input hole of the inflow block via a sealing member, and
the inflow block has an inner peripheral surface defining the input hole and being formed as the smooth sealing surface finished by one of pressurizing and pressing, the sealing member being held in contact with a part of the inner peripheral surface.

4. The fuel supply unit according to claim 2, wherein
the fuel supply unit further includes an inflow pressure sensor configured to detect pressure of the fuel gas in the inflow passage as inflow pressure,
the inflow pressure sensor includes an input pipe configured to input the inflow pressure,
the inflow block includes an input hole connected with the input pipe of the inflow pressure sensor and communicated with the inflow passage,
the input pipe of the inflow pressure sensor is connected with the input hole of the inflow block via a sealing member, and
the inflow block has an inner peripheral surface defining the input hole and being formed as the smooth sealing surface finished by one of pressurizing and pressing, the sealing member being held in contact with a part of the inner peripheral surface.

5. The fuel supply unit according to claim 2, wherein
the fuel supply unit further includes an outflow pressure sensor configured to detect pressure of the fuel gas in the outflow passage as outflow pressure,
the outflow pressure sensor includes an input pipe configured to input the outflow pressure,
the outflow block includes an input hole connected with the input pipe of the outflow pressure sensor and communicated with the outflow passage,
the input pipe of the outflow pressure sensor is connected with the input hole of the outflow block via a sealing member, and
the outflow block has an inner peripheral surface defining the input hole and being formed as the smooth sealing surface finished by one of pressurizing and pressing, the sealing member being held in contact with a part of the inner peripheral surface.

6. The fuel supply unit according to claim 4, wherein
the fuel supply unit further includes an outflow pressure sensor configured to detect pressure of the fuel gas in the outflow passage as outflow pressure,
the outflow pressure sensor includes an input pipe configured to input the outflow pressure,
the outflow block includes an input hole connected with the input pipe of the outflow pressure sensor and communicated with the outflow passage,
the input pipe of the outflow pressure sensor is connected with the input hole of the outflow block via a sealing member, and
he outflow block has an inner peripheral surface defining the input hole and being formed as the smooth sealing surface finished by one of pressurizing and pressing, the sealing member being held in contact with a part of the inner peripheral surface.

7. The fuel supply unit according to claim 3, wherein
the fuel supply unit further includes an inflow pressure relief valve configured to release the inflow pressure in the inflow passage to outside,
the inflow pressure relief valve includes an input pipe configured to input the inflow pressure,
the inflow block includes an inlet hole connected with the input pipe of the inflow pressure relief valve and communicated with the inflow passage,
the input pipe of the inflow pressure relief valve is connected with the inlet hole of the inflow block via a sealing member, and
the inflow block has an inner peripheral surface defining the inlet hole and being formed as the smooth sealing surface finished by one of pressurizing and pressing, the sealing member being held in contact with a part of the inner peripheral surface.

8. The fuel supply unit according to claim 4, wherein
the fuel supply unit further includes an inflow pressure relief valve configured to release the inflow pressure in the inflow passage to outside,
the inflow pressure relief valve includes an input pipe configured to input the inflow pressure,
the inflow block includes an inlet hole connected with the input pipe of the inflow pressure relief valve and communicated with the inflow passage,
the input pipe of the inflow pressure relief valve is connected with the inlet hole of the inflow block via a sealing member, and
the inflow block has an inner peripheral surface defining the inlet hole and being formed as the smooth sealing surface finished by one of pressurizing and pressing, the sealing member being held in contact with a part of the inner peripheral surface,

9. The fuel supply unit according to claim 5, wherein
the fuel supply unit further includes an inflow pressure relief valve configured to release the inflow pressure in the inflow passage to outside,
the inflow pressure relief valve includes an input pipe configured to input the inflow pressure,
the inflow block includes an inlet hole connected with the input pipe of the inflow pressure relief valve and communicated with the inflow passage,
the input pipe of the inflow pressure relief valve is connected with the inlet hole of the inflow block via a sealing member, and
the inflow block has an inner peripheral surface defining the inlet hole and being formed as the smooth sealing surface finished by one of pressurizing and pressing, the sealing member being held in contact with a part of the inner peripheral surface.

10. The fuel supply unit according to claim 2, wherein
the fuel supply unit further includes an outflow pressure relief valve configured to release the outflow pressure in the outflow passage to outside;
the outflow pressure relief valve includes an input pipe configured to introduce the outflow pressure,
the outflow block includes an inlet hole connected with the input pipe of the outflow pressure relief valve and communicated with the outflow passage,
the input pipe of the outflow pressure relief valve is connected with the inlet hole of the outflow block via the sealing member, and
the outflow block has an inner peripheral surface defining the inlet hole and being formed as the smooth sealing surface finished by one of pressurizing and pressing, the sealing member being held in contact with a part of the inner peripheral surface.

11. The fuel supply unit according to claim 5, wherein
the fuel supply unit further includes an outflow pressure relief valve configured to release the outflow pressure in the outflow passage to outside;
the outflow pressure relief valve includes an input pipe configured to introduce the outflow pressure,
the outflow block includes an inlet hole connected with the input pipe of the outflow pressure relief valve and communicated with the outflow passage,
the input pipe of the outflow pressure relief valve is connected with the inlet hole of the outflow block via the sealing member, and
the outflow block has an inner peripheral surface defining the inlet hole and being formed as the smooth sealing surface finished by one of pressurizing and pressing, the sealing member being held in contact with a part of the inner peripheral surface.

12. The fuel supply unit according to claim 9, wherein
the fuel supply unit further includes an outflow pressure relief valve configured to release the outflow pressure in the outflow passage to outside;
the outflow pressure relief valve includes an input pipe configured to introduce the outflow pressure,
the outflow block includes an inlet hole connected with the input pipe of the outflow pressure relief valve and communicated with the outflow passage,
he input pipe of the outflow pressure relief valve is connected with the inlet hole of the outflow block via the sealing member, and
the outflow block has an inner peripheral surface defining the inlet hole and being formed as the smooth sealing surface finished by one of pressurizing and pressing, the sealing member being held in contact with a part of the inner peripheral surface.

13. A method of manufacturing a fuel supply unit, the fuel supply unit comprising: an inflow block formed by one of casting and die casting and having an inflow passage configured to introduce fuel gas; an outflow block formed by one of casting and die casting and having an outflow passage configured to allow the fuel gas to flow out; and at least one injector configured to regulate a flow rate and pressure of the fuel gas, wherein
the injector includes an inlet pipe configured to introduce the fuel gas and an outlet pipe configured to inject the fuel gas,
the injector is placed and held between the inflow block and the outflow block,
the inflow block includes an inflow port configured to introduce the fuel gas into the inflow passage and an inlet hole connected with the inlet pipe of the injector and communicated with the inflow passage,
the outflow block includes an outflow port configured to allow the fuel gas to flow out through the outflow passage and an outlet hole connected with the outlet pipe of the injector and communicated with the outflow passage,
the inlet pipe of the injector is connected with the inlet hole of the inflow block via a sealing member and the outlet pipe of the injector is connected with the outlet hole of the outflow block via a sealing member,
an inflow pipe configured to introduce the fuel gas is connected with the inflow port of the inflow block via a sealing member and an outflow pipe configured to allow the fuel gas to flow out is connected with the outflow port of the outflow block via a sealing member,
the fuel supply unit is configured such that the fuel gas introduced into the inflow passage is injected through the injector to decompress the fuel gas, and
the inflow block has inner peripheral surfaces defining the inflow port and the inlet hole and each being formed as a smooth sealing surface finished by one of pressurizing and pressing, the sealing member being held in contact with a part of the inner peripheral surface.

14. The manufacturing method of the fuel supply unit according to claim 13, wherein the outflow block has inner peripheral surfaces defining the outflow port and the outlet hole and each being formed as the smooth sealing surface finished by one of pressurizing and pressing, the sealing member being held in contact with a part of the inner peripheral surface.

15. The manufacturing method of the fuel supply unit according to claim 13, wherein
the fuel supply unit further includes an inflow pressure sensor configured to detect pressure of the fuel gas in the inflow passage as inflow pressure,
the inflow pressure sensor includes an input pipe configured to input the inflow pressure,
the inflow block includes an input hole connected with the input pipe of the inflow pressure sensor and communicated with the inflow passage,
the input pipe of the inflow pressure sensor is connected with the input hole of the inflow block via a sealing member, and
the inflow block has an inner peripheral surface defining the input hole and being formed as the smooth sealing surface finished by one of pressurizing and pressing, the sealing member being held in contact with a part of the inner peripheral surface.

16. The manufacturing method of the fuel supply unit according to claim 14, wherein
the fuel supply unit further includes an inflow pressure sensor configured to detect pressure of the fuel gas in the inflow passage as inflow pressure,
the inflow pressure sensor includes an input pipe configured to input the inflow pressure,
the inflow block includes an input hole connected with the input pipe of the inflow pressure sensor and communicated with the inflow passage,
the input pipe of the inflow pressure sensor is connected with the input hole of the inflow block via a sealing member, and
the inflow block has an inner peripheral surface defining the input hole and being formed as the smooth sealing surface finished by one of pressurizing and pressing, the sealing member being held in contact with a part of the inner peripheral surface. 17, The manufacturing method of the fuel supply unit according to claim 14, wherein
the fuel supply unit further includes an outflow pressure sensor configured to detect pressure of the fuel gas in the outflow passage as outflow pressure,
the outflow pressure sensor includes an input pipe configured to input the outflow pressure,
the outflow block includes an input hole connected with the input pipe of the outflow pressure sensor and communicated with the outflow passage,
the input pipe of the outflow pressure sensor is connected with the input hole of the outflow block via a sealing member, and
the outflow block has an inner peripheral surface defining the input hole and being formed as the smooth sealing surface finished by one of pressurizing and pressing, the sealing member being held in contact with a part of the inner peripheral surface.

18. The manufacturing method of the fuel supply unit according to claim 16, wherein
the fuel supply unit further includes an outflow pressure sensor configured to detect pressure of the fuel gas in the outflow passage as outflow pressure,
the outflow pressure sensor includes an input pipe configured to input the outflow pressure,
the outflow block includes an input hole connected with the input pipe of the outflow pressure sensor and communicated with the outflow passage,
the input pipe of the outflow pressure sensor is connected with the input hole of the outflow block via a sealing member, and
the outflow block has an inner peripheral surface defining the input hole and being formed as the smooth sealing surface finished by one of pressurizing and pressing, the sealing member being held in contact with a part of the inner peripheral surface.
